(19) United States
(12) Patent Application Publication
(10) Pub. No.: US 2009/0219806 A1
(43) Pub. Date: Sep. 3, 2009

(54) METHOD, APPARATUS, AND SYSTEM FOR PROTECTING HEAD NODE OF POINT TO MULTIPOINT LABEL SWITCHED PATH

(75) Inventors: Guoyi Chen, Shenzhen (CN); Wei Cao, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/437,336

(22) Filed: May 7, 2009

Related U.S. Application Data
(63) Continuation of application No. PCT/CN2008/070878, filed on May 5, 2008.

(30) Foreign Application Priority Data
Jun. 27, 2007 (CN) 200710122703.1

(51) Int. Cl. H04L 12/26

(52) U.S. Cl. 370/219

(57) ABSTRACT

A method for protecting the head node of a Point to Multipoint Label Switched Path (P2MP LSP) includes: a Backup Head Node (BHN) establishes a backup LSP from the BHN to all Merge Points (MPs), where the backup LSP bypasses a Master Head Node (MHN); the MHN forwards data along an LSP already established between the MHN and the MPs; when a head node switchover condition is met, the BHN is switched to a master mode to forward data along the backup LSP established between the BHN and the MPs. A system and apparatus for protecting the head node are also provided. With the head node protection solution provided by the present disclosure, the head node is well protected and the protection mechanisms for the P2MP LSP are therefore more complete. This can further promote the scale deployment of P2MP systems.

### CROSS-REFERENCE TO RELATED APPLICATIONS

This application claims priority to Chinese Patent Application No. 200710122703.1, filed with the Chinese Patent Office on Jun. 27, 2007 and entitled “Method, Apparatus, and System for Protecting Head Node of a Point to Multipoint Label Switched Path”, which is incorporated herein by reference in its entirety.

### FIELD

The present disclosure relates to communication technologies, and in particular, to a method, apparatus, and system for protecting a head node based on a Point to Multipoint Label Switched Path (P2MP LSP).

### BACKGROUND

The statements in this section merely provide background information related to the present disclosure and may not constitute prior art.

Multicast is a point to multipoint communication mode. Unlike the widely applied unicast technology, multicast reduces the replication of data contents by establishing optimal multicast forwarding paths, which can significantly reduce consumption of network resources by multiparty communication. Currently, the main protocol for Internet Protocol (IP) multicast is Protocol Independent Multicast (PIM).

Multi-Protocol Label Switching (MPLS) is a routing technology widely adopted in IP networks, where label distribution is based on the Label Distribution Protocol (LDP). MPLS is generally applicable to IP forwarding of unicast. With the development of unicast and the rise of Internet Protocol Television (IPTV), MPLS multicast gradually becomes a subject of research. Now, two methods are available for establishing a P2MP LSP: based on LDP and based on Resource Reservation Protocol-Traffic Engineering (RSVP-TE).

MPLS based multicast is now able to provide multiple protection solutions, where the most widely used is path protection and partial protection. Path protection implements protection by establishing an extra backup P2MP LSP in parallel with an existing master P2MP LSP. When the master LSP fails, traffic is directly transferred to the backup LSP. Normally, the ratio of master LSPs to backup LSPs is 1:1 at the head end.

Partial protection is classified into link protection and node protection. Link protection is specific to a link requiring protection, where a unicast backup LSP that bypasses the protected link is established in advance so that traffic can be transferred to the backup LSP when the protected link fails. In node protection, a unicast backup LSP that bypasses a protected node is established in advance so that traffic can be transferred to the backup LSP when the protected node fails. With partial protection, the ratio of backup LSPs to master LSPs may be 1:N, which means one backup LSP may support multiple master LSPs.

Currently, a technology known as bypass tunnel is proposed for protection of a P2MP LSP, where a P2MP bypass tunnel that bypasses a protected link or node is established in advance so as to reduce the replication of data when the protected link or node fails.

To meet the possible need of protecting the egress of a multicast tree at the deployment of MPLS multicast, an egress protection technology is now also available.

The inventor, however, finds that no solution is available for protecting a head node despite the multiple protection technologies. In actual deployment, especially deployment of IPTV systems, the needs for head node protection are stronger and stronger. Because a failed head node means service interruption for all users under the entire P2MP tree, protection of the head node is more important than any other protection in terms of the protection effect and significance.

### SUMMARY

Various embodiments of the present disclosure provide a method, apparatus and system for protecting a head node of a P2MP LSP.

A method for protecting a head node of a P2MP LSP includes:

establishing a backup LSP from a Backup Head Node (BHN) to related Merge Points (MPs), where the backup LSP bypasses a Master Head Node (MHN); and

switching the BHN to an active mode to forward data along the backup LSP when a head node switchover condition is met.

A system for protecting a head node of a P2MP LSP includes:

an MHN, adapted to forward data along an LSP already established between the MHN and MPs; and

a BHN, adapted to establish a backup LSP from the BHN to all MPs, where the backup LSP bypasses the MHN, and act as the MHN to forward data along the backup LSP when a head node switchover condition is met.

A head node apparatus includes:

a backup LSP establishing unit, adapted to establish a backup LSP from the head node apparatus to all MPs according to information of a protected path that covers an MHN, where the backup LSP bypasses the MHN;

a switching unit, adapted to switch the head node apparatus to an active mode and notify a data transmitting unit when a head node switchover condition is met; and

the data transmitting unit, adapted to forward data along the backup LSP.

Another head node apparatus includes:

an LSP establishing unit, adapted to establish an LSP from the head node apparatus to all MPs;

a switching unit, adapted to switch the head node apparatus to a non-master mode and notify a data transmitting unit to stop data transmission when a head node switchover condition is met; and

the data transmitting unit, adapted to forward data along the established LSP and stop forwarding data along the LSP upon reception of a stop notification from the switching unit.

In the solution provided by the embodiments of the disclosure, a backup LSP is established between a BHN and related MPs, where the backup LSP bypasses the MHN. When a head node switchover condition is met, the BHN is switched to a master mode to forward data along the backup LSP. Thereby, the head node is well protected and the protection mechanisms for the P2MP LSP are greatly enhanced. Further, this will promote the scale deployment of P2MP systems.

### BRIEF DESCRIPTION OF THE DRAWINGS

The disclosure will become more fully understood from the detailed description given herein below by referring to the accompanying drawings among which:

FIG. 1 shows a network structure for protection of a master head node according to an embodiment of the disclosure;

FIG. 2 shows a head node protection process of a P2MP LSP according to an embodiment of the disclosure; and

FIG. 3 shows a structure of a head node apparatus provided by an embodiment of the disclosure.

### DETAILED DESCRIPTION

The following description is merely exemplary in nature and is not intended to limit the present disclosure, application, or uses. The following describes the present disclosure through specific embodiments.

Before description of the specific solution, a few terms are explained:

Master Head Node (MHN): A head node that initiates a request for establishing a given P2MP LSP.

Merge Point (MP): A leaf point or branch point directly connected with the MHN of a given P2MP LSP. One P2MP LSP may have one or more MPs.

Backup Head Node (BHN): For a given P2MP LSP, the BHN establishes a backup LSP from itself to all MPs. When the MHN fails, the BHN replaces the MHN to act as a head node.

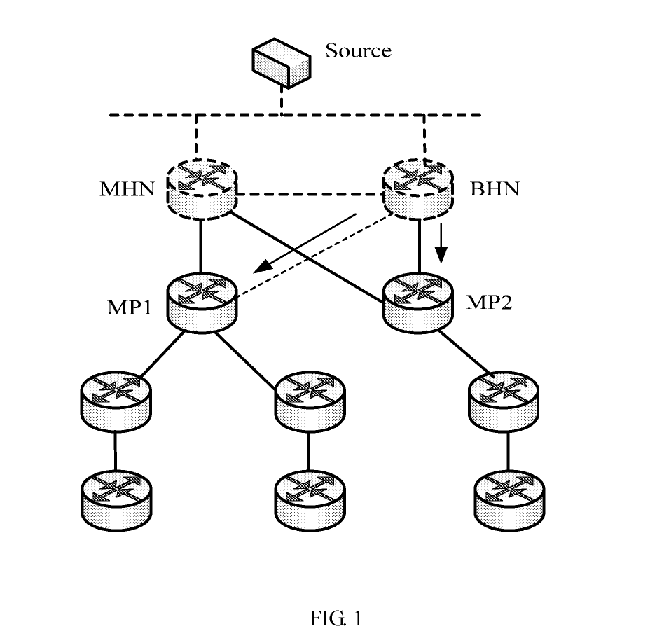

FIG. 1 shows a network structure for protection of an MHN in an embodiment of the disclosure. In the figure, a thick real line represents an established P2MP LSP, an arrowed line represents a protective tunnel.

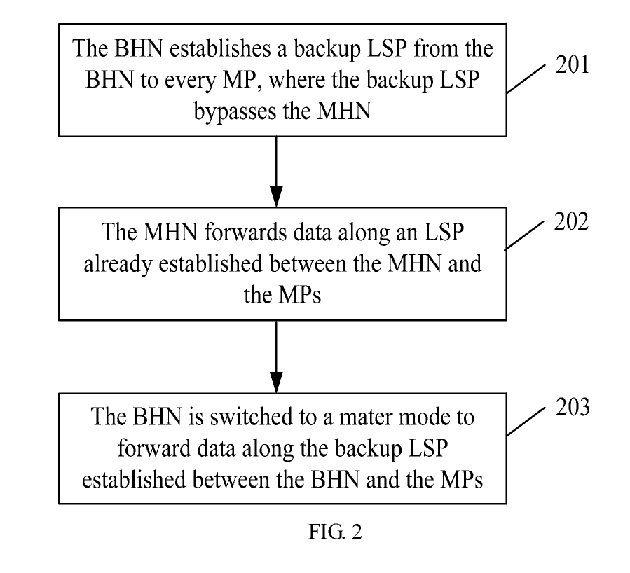

FIG. 2 shows a head node protection process of a P2MP LSP in an embodiment of the disclosure. According to an embodiment of the disclosure, a method for protecting the head node of a P2MP LSP includes:

201. The BHN establishes a backup LSP from itself to all MPs. The backup LSP bypasses the MHN.

202. In a normal scenario, the MHN forwards data along an LSP established between the MHN and the MPs.

203. When a head node switchover condition is met, the BHN is switched to a master mode to forward data along the backup LSP established between the BHN and the MPs.

According to the method provided in this embodiment of the disclosure, when it is necessary to protect a head node, the following processes are performed:

1. For a given P2MP LSP, the MHN first obtains basic information of the BHN and then the MHN sends information of the P2MP LSP requiring head node protection for establishing a protected path to the BHN. The information for establishing a protected path sent by the MHN to the BHN may be carried in a Path message of RSVP-TE; or a new message may be defined to carry the information.

The process of obtaining basic information of the BHN includes: the MHN queries the Network Management System (NMS) to obtain basic information of the BHN; or the MHN obtains basic information of the BHN from received configuration information; or the MHN obtains basic information of the BHN from an active notification received from the BHN. The basic information of the BHN includes address and capacity information of the BHN.

The process of sending information for establishing a protected path to the BHN includes:

The MHN establishes a connection with the BHN, encapsulates the information for establishing a protected path in a newly defined message, and sends the information for establishing a protected path to the BHN via the new message; or

The RSVP-TE Path message is extended and the MHN sends the information for establishing a protected path to the BHN via the extended Path message directly to the BHN; or

The RSVP-TE Path message is extended and the MHN sends the information for establishing a protected path to an MP via the extended Path message, and the MP forwards the received information to the BHN; or

The MHN sends the information for establishing a protected path to the BHN via the NMS.

The RSVP-TE Path message is extended by adding a new object or extending an existing object.

The information for establishing a protected path includes: a P2MP SESSION Object, a SENDER_TEMPLATE Object, and addresses of all MPs; the information may further include basic information of the BHN and other necessary information. Or the information for establishing a protected path includes: P2MP ID and Extended Tunnel ID of the P2MP SESSION Object, Sender Address, Sub-Group Originator ID and P2MP LSP ID of the SENDER_TEMPLATE Object, and addresses of all MPs; the information may further include basic information of the BHN and other necessary information.

2. Upon reception of the Path message or the newly defined message, the BHN analyzes the message and extracts and stores the path feature information; then the BHN establishes one or more backup LSPs that bypass the MHN from the BHN to all MPs according to the path feature information, where the backup LSPs may be point to point (P2P) or P2MP.

The path feature information may include: a P2MP SESSION Object, a SENDER_TEMPLATE Object, and addresses of all MPs. Or, the path feature information may include: P2MP ID and Extended Tunnel ID of the P2MP SESSION Object, Sender Address, Sub-Group Originator ID and P2MP LSP ID of the SENDER_TEMPLATE Object, and addresses of all MPs.

It is understandable that the information received by the BHN may be from the MHN, or an MP, or the NMS. When the information is received from an MP or the NMS, the information for establishing a protected path should also include basic information of the BHN to help the MP or NMS deliver the information.

The BHN may establish a P2P LSP in the following process:

The BHN generates a Path message for each MP and sends the Path message to the MP. The Path message carries path feature information and an identifier indicating the LSP is a backup of the P2MP LSP; the Path message may also carry establishment priority, hold priority and protection mode (node protection or link protection, whether to allow local recovery, whether to include certain links, and whether to exclude certain links), and bandwidth requirement of the backup LSP.

When the MP receives the Path message, the MP distributes a label and reserves resources, and returns a REVS response to the BHN. The MP also binds the LSP and the protected P2MP LSP to finish establishing a backup LSP. Here, binding means the MP compares the path feature information carried in the received Path message and the path feature information of the LSP already existing locally. If the Session Object and LSP ID are identical, the backup LSP and the protected LSP are associated. When receiving data from the backup LSP, the MP forwards the data along the subtree, where the root node is the MP. This subtree is a part of the protected P2MP LSP.

The BHN may establish a P2MP LSP in the following process:

The BHN generates one or more Path messages and sends the Path message(s) to MPs. The Path message carries path feature information and an identifier indicating the LSP is a backup of the P2MP LSP. The Path message may also carry establishment priority, hold priority and protection mode (node protection or link protection, whether to allow local recovery, whether to include certain links, and whether to exclude certain links), and bandwidth requirement of the backup P2MP LSP. If the BHN generates one Path message, the Path message is intended for all MPs; if the BHN generates more than one Path message, two scenarios may apply: each Path message matches one MP, or one Path message matches multiple MPs, depending on actual needs. The BHN establishes a P2MP LSP that takes the BHN as a root and all MPs as leaves.

When the MP receives the Path message, the MP distributes a label and reserves resources, and returns a REVS response to the BHN. The MP also binds the LSP and the protected P2MP LSP to finish establishing a backup LSP. Here, binding means the MP compares the path feature information carried in the received Path message and the path feature information of the LSP already existing locally. If the Session Object and LSP ID are identical, the backup LSP and the protected LSP are associated. When receiving data from the backup LSP, the MP forwards the data along the subtree, where the root node is the MP. This subtree is a part of the protected P2MP LSP.

3. The MHN may trigger a head node switchover actively. In this scenario, the MHN sends a notification message to the BHN, telling the BHN to perform switchover; after receiving the switchover notification, the BHN starts to forward data along the LSP already established between the BHN and the MPs. The BHN may also detect MHN failure via a certain failure detection mechanism, such as Bidirectional Forwarding Detection (BFD) and Quick Hello message; if the BHN detects failure of the MHN, the BHN switches itself to a master mode and starts to forward data along the LSP already established between the BHN and the MPs. This means, the head node switchover condition may be: the MHN triggers head node switchover actively or the BHN detects failure of the MHN.

When the MHN recovers to work, the MHN needs to reestablish the P2MP LSP. Specifically, the MHN may establish the P2MP LSP independently, or the BHN sends the information from the MHN for establishing a protected path back to the MHN to help the MHN reestablish the P2MP LSP. Here, the BHN sends the information for establishing a protected path back to the MHN in the same way as in process 1.

When the MHN recovers to normal, the BHN notifies the MHN of head node switchover or the MHN actively notifies the BHN of switchover. After the switchover, the BHN stops forwarding data along the LSP established between the BHN and the MPs while the MHN acts as a head node to forward data along the LSP established between the MHN and the MPs. The BHN may notify the MHN of head node switchover in the following way: the BHN notifies the MHN directly; or the BHN notifies the MHN via the MNS.

An embodiment of the disclosure provides a system for protecting a head node of a P2MP LSP. The system includes:

an MHN, adapted to forward data along an LSP established between the MHN and MPs; and

a BHN, adapted to establish a backup LSP from the BHN to all MPs, where the backup LSP bypasses the MHN, and act as the MHN to forward data along the backup LSP established between the BHN and MPs when a head node switchover condition is met.

The head node switchover condition may be: the MHN triggers head node switchover actively or the BHN detects failure of the MHN.

When the MHN recovers to work, the MHN is further adapted to reestablish the P2MP LSP.

The BHN is also adapted to notify the MHN of head node switchover when the MHN recovers to normal and after the switchover, the BHN stops forwarding data long the backup LSP established between the BHN and MPs while the MHN acts as a head node to forward data along the LSP established between the MHN and MPs.

The MHN is also adapted to notify the BHN of head node switchover when the MHN recovers to normal and after the switchover, the BHN stops forwarding data long the backup LSP established between the BHN and MPs while the MHN acts as a head node to forward data along the LSP established between the MHN and MPs.

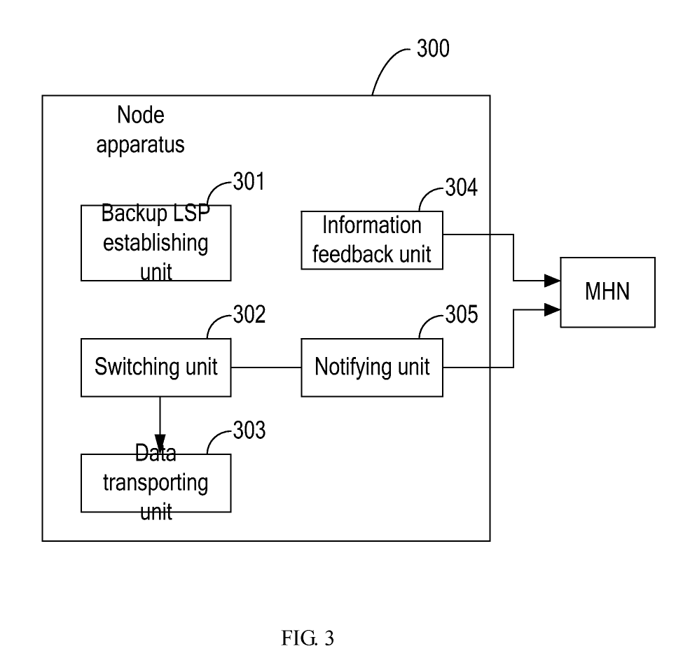

As shown in FIG. 3, a head node apparatus 300 provided in an embodiment of the disclosure includes:

a backup LSP establishing unit 301, adapted to establish a backup LSP from the head node apparatus to all MPs according to information of a protected path that covers the MHN, where the backup LSP bypasses the MHN;

a switching unit 302, adapted to switch the head node apparatus to a master mode and notify a data transmitting unit 303 when a head node switchover condition is met; and

the data transmitting unit 303, adapted to forward data along the backup LSP established between the BHN and MPs.

The head node apparatus 300 further includes:

an information feedback unit 304, adapted to send information from the MHN for establishing a protected path back to the MHN to help the MHN reestablish the P2MP LSP.

The head node apparatus 300 further includes:

a notifying unit 305, adapted to notify the MHN of head node switchover and send the switchover information to the switching unit 302;

the switching unit 302, adapted to switch the head node apparatus to a non-master mode according to the notification and notify the data transmitting unit 303; and

the data transmitting unit 303, adapted to stop forwarding data along the backup LSP established between the BHN and MPs.

A head node apparatus 400 provided in another embodiment of the disclosure includes:

an LSP establishing unit 401, adapted to establish an LSP from the head node to all MPs;

a switching unit 402, adapted to switch the head node to a non-master mode and notify a data transmitting unit 403 to stop data transmission when a head node switchover condition is met; and

the data transmitting unit 403, adapted to forward data along the LSP established between the MHN and MPs; and stop forwarding data along the LSP established between the MHN and MPs upon reception of a stop notification from the switching unit 402.

When the head node recovers to work, the LSP establishing unit 401 is further adapted to reestablish the P2MP LSP.

The switching unit 402 is also adapted to notify the BHN of head node switchover after determining the head node has recovered to normal.

All or part of an embodiment of the disclosure may be implemented by a software program, which may be stored in a readable storage medium, such as a compact disk, a hard disk and a floppy disk.

To sum up, the embodiments of the disclosure provide a head node protection solution, where a backup LSP is established between a BHN and related MPs. The backup LSP does not cover the MHN. When a head node switchover condition is met, the BHN is switched to a master mode to forward data along the backup LSP. Thereby, the head node is well protected and the protection mechanisms for the P2MP LSP are more complete. Further, this will promote the scale deployment of P2MP systems.

Although the present disclosure has been described through several exemplary embodiments, the disclosure is not limited to such embodiments. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

1. A method for protecting a head node of a Point to Multipoint Label Switched Path, P2MP LSP, comprising:
establishing a backup LSP from a Backup Head Node, BHN, to related Merge Points, MPs, wherein the backup LSP bypasses a Master Head Node, MHN; and
switching the BHN to a master mode to forward data along the backup LSP when a head node switchover condition is met.

2. The method of claim 1, wherein the process of establishing the backup LSP from the BHN to related MPs comprises:
obtaining information of a protected path that covers the MHN; and
obtaining feature information of the protected path from the information of the protected path and establishing the backup LSP from the BHN to related MPs according to the feature information, wherein the backup LSP does not cover the MHN.

3. The method of claim 2, wherein the path feature information comprises:
a P2MP SESSION Object, a SENDER_TEMPLATE Object, and addresses of all MPs; or, the path feature information comprises: P2MP ID and Extended Tunnel ID of the P2MP SESSION Object, Sender Address, Sub-Group Originator ID and P2MP LSP ID of the SENDER_TEMPLATE Object, and addresses of all MPs.

4. The method of claim 1, wherein before head node switchover, the method further comprises: forwarding, by the MHN, data along an LSP already established between the MHN and MPs.

5. The method of claim 2, further comprising:
obtaining, by the MHN, basic information of the BHN; and
switching the BHN to a master mode according to the basic information of the BHN.

6. The method of claim 5, wherein
the process of obtaining basic information of the BHN comprises:
obtaining, by the MHN, basic information of the BHN from a network management system; or obtaining, by the MHN, basic information of the BHN from received configuration information; or
obtaining, by the MHN, basic information of the BHN from an active notification from the BHN; and
the basic information of the BHN comprises address and capacity information of the BHN.

7. The method of claim 2, wherein the process of obtaining information of the protected path that covers the MHN comprises:
establishing a connection between the MHN and the BHN, encapsulating the information of the protected path in a newly defined message, and sending the information of the protected path to the BHN via the newly defined message; or
extending a Path message of Resource Reservation Protocol-Traffic Engineering, RSVP-TE; and sending, by the MHN, the information of the protected path to the BHN via the extended Path message directly to the BHN; or
extending the RSVP-TE Path message; sending, by the MHN, the information of the protected path to an MP via the extended Path message; and sending, by the MP, the received information to the BHN; or
sending, by the MHN, the information of the protected path to the BHN via a network management system.

8. The method of claim 7, wherein the process of extending the RSVP-TE Path message comprises: adding a new object or extending an existing object.

9. The method of claim 5, wherein the information of the protected path that covers the MHN is from the MHN, or an MP or a network management system.

10. The method of claim 7, wherein when the information of the protected path that covers the MHN is from an MP or a network management system, the information of the protected path further comprises basic information of the BHN.

11. The method of claim 2, wherein the backup LSP established from the BHN to related MPs is a point to point LSP or a point to multipoint LSP.

12. The method of claim 11, wherein the process of establishing a point to point LSP comprises:
generating, by the BHN, a Path message for each MP, and sending the Path message to the MP, wherein the Path message carries path feature information and an identifier indicating the LSP is a backup of the P2MP LSP;
upon reception of the Path message, distributing, by the MP, labels and reserving resources, sending a response message to the BHN, and binding the LSP with the protected P2MP LSP to establish a backup LSP; and
forwarding, by the MP, received data along a subtree rooted at the MP when receiving data from the backup LSP.

13. The method of claim 11, wherein the process of establishing a point to multipoint LSP comprises:
generating, by the BHN, a Path message for each MP, and sending the Path message to the MP, wherein the Path message carries path feature information and an identifier indicating the LSP is a backup of the P2MP LSP; establishing, by the BHN, a P2MP LSP which takes the BHN as a root and related MPs as leaves;
upon reception of the Path message, distributing, by the MP, labels and reserving resources, sending a response message to the BHN, and binding the LSP with the protected P2MP LSP to establish a backup LSP; and
forwarding, by the MP, received data along a subtree rooted at the MP when receiving data from the backup LSP.

14. The method of claim 1, wherein when the MHN recovers to be available, the method further comprises:
reestablishing a P2MP LSP based on the MHN; and
the process of reestablishing the P2MP LSP comprises:
reestablishing, by the MHN, the P2MP LSP independently; or
sending the information of the protected path from the MHN back to the MHN to help the MHN reestablish the P2MP LSP.

15. The method of claim 1, wherein after the MHN recovers to normal, the method further comprises:
notifying the MHN of head node switchover; or
notifying, by the MHN, the BHN actively of head node switchover, stopping, by the BHN, forwarding data along the backup LSP; and acting, by the MHN, as a head node to forward data along the LSP established between the MHN and the related MPs.

16. A system for protecting a head node of a Point to Multipoint Label Switched Path, P2MP LSP, the system comprising:
a Master Head Node, MHN, adapted to forward data along an LSP established between the MHN and Merge Points, MPs; and
a Backup Head Node, BHN, adapted to establish a backup LSP from the BHN to all MPs, wherein the backup LSP bypasses the MHN, and act as the MHN to forward data along the backup LSP established between the BHN and MPs when a head node switchover condition is met.

17. The system of claim 16, wherein
after the MHN recovers to normal, the BHN notifies the MHN of head node switchover; or the MHN notifies the BHN of head node switchover; and
after the switchover is complete, the BHN stops forwarding data along the backup LSP and the MHN acts as a head node to forward data along the established LSP.

18. A head node apparatus, comprising:
a backup LSP establishing unit, adapted to establish a backup Label Switched Path, LSP, from the head node apparatus to all Merge Points, MPs, according to information of a protected path that covers a Master Head Node, MHN, wherein the backup LSP bypasses the MHN;
a switching unit, adapted to switch the head node apparatus to a master mode and notify a data transmitting unit when a head node switchover condition is met; and
the data transmitting unit, adapted to forward data along the backup LSP.

19. The head node apparatus of claim 18, further comprising: an information feedback unit, adapted to send the information of the protected path from the MHN back to the MHN to help the MHN reestablish a P2MP LSP.

20. The head node apparatus of claim 18, further comprising:
a notifying unit, adapted to notify the MHN of head node switchover and send switchover information to the switching unit;
the switching unit, adapted to switch the BHN to a non-master mode according to the received notification and notify the data transmitting unit; and
the data transmitting unit, adapted to stop forwarding data along the backup LSP.
